(19) United States
(12) Patent Application Publication
(10) Pub. No.: US 2006/0260443 A1
(43) Pub. Date: Nov. 23, 2006

(54) Fastening system and method of fastening objects with enhanced security

(76) Inventors: Durward I. Faries JR., Las Vegas, NV (US); Bruce R. Heymann, Vienna, VA (US); David Hendrix, Ashburn, VA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/487,470

(22) Filed: Jul. 17, 2006

Related U.S. Application Data
(62) Division of application No. 10/996,050, filed on Nov. 24, 2004.
(60) Provisional application No. 60/524,877, filed on Nov. 26, 2003.

(51) Int. Cl. B25B 13/48; B25B 13/56

(52) U.S. Cl. 81/176.2

(57) ABSTRACT

A fastening system according to the present invention includes a fastening device and a specialized tool. The fastening device is manipulable by the specialized tool and includes a threaded distal portion and a proximal receptacle to receive the tool. The tool is designed to interface the fastening device via the receptacle and rotate the threaded portion to engage or be removed from objects.

### CROSS-REFERENCE TO RELATED APPLICATIONS

This application claims priority from U.S. Provisional Patent Application Ser. No. 60/524,877, entitled “Fastening Device and Method of Fastening Objects with Enhanced Security” and filed Nov. 26, 2003. The disclosure of the above-mentioned provisional application is incorporated herein by reference in its entirety.

### BACKGROUND OF THE INVENTION

1. Technical Field

The present invention pertains to fastening systems. In particular, the present invention pertains to a fastening system including a fastening device and a specialized tool to fastens objects with enhanced security.

2. Discussion of the Related Art

Various types of objects require fastening in a tamper-resistant manner. These objects may include containers or compartments (e.g., phone, cable and electrical boxes, etc.) and internal compartments of medical or other devices. The objects are generally required to be fastened securely to prevent unauthorized parties from gaining access to the object internal components. The related art has provided various devices for enhanced security. For example, U.S. Pat. No. 3,519,979 (Bodenstein) discloses a tamper-proof electrical termination for CATV terminal boxes. The tap termination includes a plug, a first end of which is screw-connected to the terminal tap and the second end of which has a configuration for mating with an associated key. A sleeve is attached to the plug and, although fixed in longitudinal relation to it, is capable of rotation around it. The sleeve projects past the second end of the plug and has a hollow bore for insertion of the key therein. The key has an end which mates with the second end of the plug. The plug can be unscrewed from the terminal box only by use of the special key which is not available to unauthorized personnel. The plug includes two notches or slots, while the key includes two projections for mating with the slots.

U.S. Pat. No. 4,569,259 (Rubin et al.) discloses a correspondingly keyed combination of a round-headed bolt fastener in a generally cylindrical socket, preferably for use in securing an automobile wheel cover against theft. The fastener has a plurality of axial slots, or lock impressions, about the periphery of the circular head which may be spaced in accordance with a preselected code. The wrench socket is provided with a corresponding number of key elements projecting inward from the cylindrical wall of the socket, the position of the key elements being in accordance with a preselected code. When the key code of the wrench matches the lock code of the fastener, the wrench socket may be slipped over the fastener head with the key elements engaging the lock impressions so that the wrench may tighten or un-tighten the fastener. The fastener has an axial recess extending from the outer face of the head with an inner beveled surface about the recess opening. The head also has an outer beveled surface extending about its outer periphery which provides a bearing surface for supporting the key elements during the rotation of the socket until the notch position of the key elements in the lock impressions is reached. The socket has an axial pin extending flush with the end plane of the socket for alignment with the fastener head recess to guide the wrench during initial engagement with the head. The socket also has an inner angle portion extending between the base of the socket and the axial wall portion which matches the angle of the outer beveled surface of the fastener head. When the socket is in full engagement on the fastener head, the engagement of the central pin on the axial recess and the contact of the angled surface of the socket with the beveled surface of the head serve to stabilize the alignment of the wrench socket on the fastener head during transmission of torque from the wrench to the fastener.

U.S. Pat. No. 5,666,831 (Doros) discloses a locking system comprising a locking fastener having tamper-resistant features and a special key having a bit at one end when engaging a socket in the head of the locking fastener to rotate the latter. The internal configuration of the socket corresponds to an external configuration of the bit, and the corresponding contour of the socket prevents the fastener from being turned by tools other than the special key. The fastener may have left-handed threads on its shaft and its head may be recessed in a counterbore in a closure part to prevent gripping tools from gripping an external surface of the head. An axial socket within the head of the screw is defined by a bottom wall and a side wall. The interior contour of a major portion of the socket side wall is preferably substantially cylindrical, while a remaining portion of the side wall is provided by a groove forming a lateral arch. The bit of the key has an external contour conforming to the internal contour of the socket and preferably comprises a substantially cylindrical body defining an axial channel with an elongated slot and an elongated pin receivable and fixed in the channel to form a laterally projecting tooth.

The fastening devices described above suffer from several disadvantages. In particular, the Bodenstein and Doros fastener heads includes a notch or slot contained within a receptacle that surrounds the fastener. These slots are generally prone to stripping, thereby rendering a corresponding key for the fastener ineffective. Further, the key to the Doros fastener head includes two engaging components that are adhered or soldered together. These engaging components may separate, thereby rendering the key ineffective to manipulate the associated fastener. In addition, the Rubin et al. fastener includes notches on the fastener head exterior. Thus, the head of the fastener generally protrudes from the object being secured to enable a wrench to engage and manipulate the fastener. This protrusion may consequently interfere with functional or operational aspects of the object.

### OBJECTS AND SUMMARY OF THE INVENTION

Accordingly, it is an object of the present invention to reliably secure objects via a fastening system.

It is another object of the present invention to prevent tampering with fastened objects by unauthorized parties.

Yet another object of the present invention is to secure objects with a fastening device that renders common tools ineffective to manipulate the device.

The aforesaid objects may be achieved individually and/or in combination, and it is not intended that the present invention be construed as requiring two or more of the objects to be combined unless expressly required by the claims attached hereto.

According to the present invention, a fastening system includes a fastening device and a specialized tool. The fastening device is manipulable by the specialized tool and includes a threaded distal portion and a proximal receptacle to receive the tool. The tool is designed to interface the fastening device via the receptacle and rotate the threaded portion to engage or be removed from objects.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a view in perspective of a fastening device according to the present invention.

FIG. 2 is a view in perspective of a tool for manipulating the fastening device of FIG. 1 according to the present invention.

FIG. 3 is an exploded view in perspective of the tool of FIG. 2 engaging the fastening device of FIG. 1.

FIG. 4 is a view in perspective and partial section of the tool of FIG. 2 engaging the fastening device of FIG. 1 mounted within an object.

FIG. 5 is a view in perspective of an alternative embodiment of the fastening device of FIG. 1 according to the present invention.

FIG. 6 is a view in perspective of a tool for manipulating the fastening device of FIG. 5 according to the present invention.

FIG. 7 is an exploded view in perspective of the tool of FIG. 6 engaging the fastening device of FIG. 5.

FIG. 8 is a view in perspective and partial section of the tool of FIG. 6 engaging the fastening device of FIG. 5 mounted within an object.

FIG. 9 is an exploded view in perspective of a thermal treatment system employing the fastening system of the present invention to secure thermal treatment system components.

### DETAILED DESCRIPTION OF THE PREFERRED EMBODIMENTS

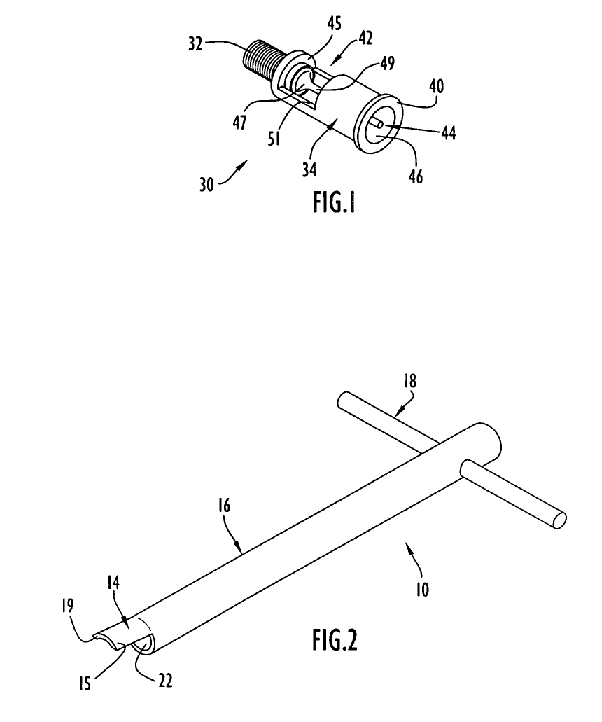

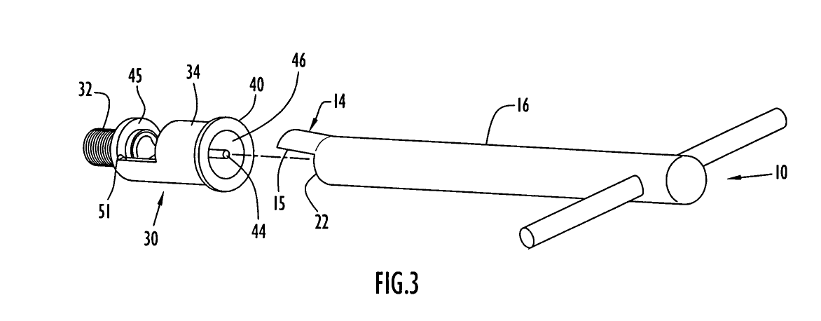

A fastening system according to the present invention for securing objects with enhanced security includes a fastening device and a tool to engage the fastening device. The fastening device according to the present invention is illustrated in FIG. 1. Specifically, fastening device 30 is in the form of a threaded element or screw that is manipulable by a tool 10 (FIG. 2). The fastening device provides enhanced security since common tools are generally ineffective to manipulate the device, thereby preventing tampering of fastened objects by unauthorized parties. The fastening device includes a distal threaded member 32 and a tool receptacle 34 disposed at a device proximal portion. The threaded member is in the form of a substantially cylindrical rod extending distally from a substantially central location on the receptacle distal end with threads disposed on an exterior rod surface. Receptacle 34 is substantially cylindrical and includes a diameter greater than that of the threaded member. The receptacle extends proximally from the threaded member and includes a closed distal end and an open proximal end with a flange 40 radially extending from the peripheral edge of the receptacle proximal end.

A substantially cylindrical channel 46 is defined within the receptacle with a guide element 44 generally concentrically disposed therein and extending from the receptacle closed distal end to the receptacle open proximal end. The channel includes dimensions sufficient to receive tool 10 (FIG. 2) as described below. The guide element includes a base 47 and a rod 49 extending therefrom. The base is attached to and extends proximally from the distal end of the receptacle, and includes a substantially frusto-conical configuration that tapers proximally toward the rod. The rod is substantially cylindrical and extends proximally toward the receptacle open proximal end from a substantially central location on the base. The rod diameter is smaller than that of channel 46 to define a substantially annular gap within the channel between the guide element and the interior surface of the receptacle.

The distal portion of receptacle 34 includes a substantially rectangular cutout section or window 42. The window extends proximally from the receptacle distal end for slightly less than half the receptacle length and angularly about the receptacle for approximately one-hundred eighty degrees. A ledge 45 is formed by the window at the distal end of the receptacle, while the window vertical edges provide one or more contact areas 51 to enable tool 10 to manipulate the fastening device as described below.

Threaded member 32 typically engages an opening defined within an object, where a specialized tool is utilized to manipulate the fastening device to engage (e.g., tighten) or be removed from (e.g., loosen the device from) the object opening. Since common tools are generally ineffective with respect to the fastening device, the system enhances security and prevents tampering by unauthorized parties. A tool for manipulating the fastening device according to the present invention is illustrated in FIG. 2. Specifically, tool 10 includes a distal engaging member 14, a shank or shaft 16 and a proximal gripping member 18. The gripping member is configured to permit a user to grasp the tool in order to manipulate fastening device 30 (FIG. 1). Gripping member 18 is in the form of a rod that is transversely disposed through a proximal portion of shank 16. The rod may be fixed to and/or disposed through the shank in any suitable fashion (e.g., welding, a screw or fastening pin inserted through the tool, apertures, etc.). Shank 16 includes a substantially cylindrical body contoured for compatibility with the interior of receptacle 34, and a channel 22 defined therein with dimensions sufficient to receive guide element rod 49.

Engaging member 14 includes a protrusion or tab 15 extending generally axially from the distal end of the shank. The protrusion is substantially rectangular and includes an arcuate configuration to accommodate window section 42 of the fastening device (FIG. 1). The protrusion includes dimensions sufficient to permit insertion within window 42 and is configured to extend radially outward from the shank distal end (e.g., bends slightly outward with respect to the shank exterior surface). This enables the engaging member to obviate base 47 and become positioned within window 42 when the tool is inserted into the receptacle. The degree of radial extension is sufficient to enable distal edge 19 of engaging member 14 to contact ledge 45 and become substantially flush with the receptacle exterior surface. The protrusion applies force to contact areas 51 of the window (FIG. 1) to manipulate the fastening device in response to the application of torque applied by a user to tool 10 as described below.

The manner in which tool 10 engages fastening device 30 is illustrated in FIG. 3. Specifically, the distal end of tool 10 is axially inserted into the fastening device open proximal end and through receptacle channel 46. Guide element 44 is received within tool channel 22, and the tool is urged distally to position engaging member 14 (e.g., and protrusion 15) within window 42 with protrusion 15 engaging contact areas 51 as described above. The tool may be rotated, if necessary, to position the engaging member coincident and within the window. Force applied to the tool presses protrusion 15 against a contact area to rotate or manipulate the fastening device. This configuration provides enhanced security since common tools are generally ineffective to manipulate the fastening device, thereby preventing tampering by unauthorized parties.

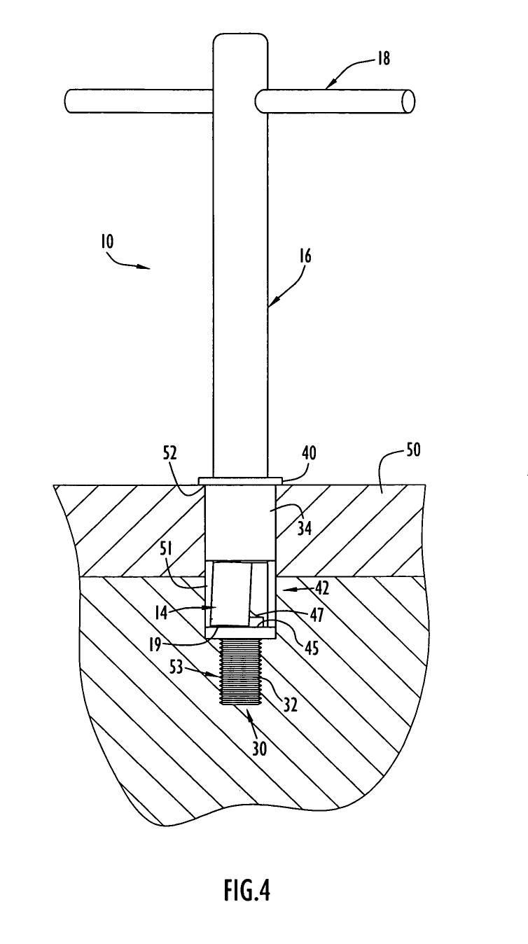

Operation of the fastening system is described with reference to FIG. 4. Initially, fastening device 30 is detachably secured to an object 50 (e.g., a wall, cabinet, etc.) by inserting the fastening device into a passage 52 defined in the object. The passage preferably includes an upper section with dimensions sufficient to receive receptacle 34 and a lower section comprising a threaded channel 53 to engage threaded member 32. In order to rotate the fastening device for engagement with the threaded channel, tool 10 is axially inserted into tool receptacle 34 via the open proximal end. Guide element 44 is received in tool channel 22, where the tool is urged distally into receptacle channel 46 until protrusion 15 is proximate base 47. The tool may be rotated, if necessary, to position protrusion 15 coincident and within window 42. The protrusion is positioned in the window with protrusion distal edge 19 contacting ledge 45 and side protrusion edges positioned to engage corresponding contact areas 51. The tool may be rotated by a user to press the protrusion against a corresponding contact area and rotate or manipulate the fastening device to enable threaded member 32 to engage the threaded channel. Preferably, once secured, the fastening device receptacle is generally inset with respect to the exterior surface of the object (e.g., flange 40 is generally flush with the object surface) to prevent tampering with common tools. The tool may be rotated in a reverse direction to release the fastening device from an object.

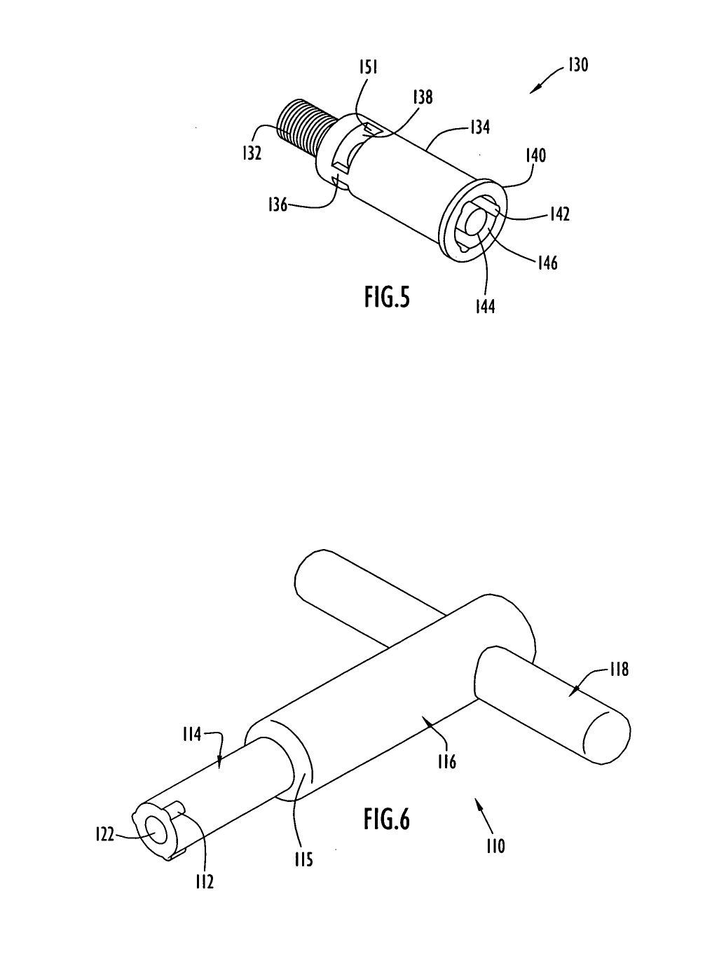

An alternative embodiment of the fastening system of the present invention is illustrated in FIG. 5. Initially, the alternative fastening system is similar to the fastening system described above, except that the fastening device receptacle and tool include a modified configuration to manipulate the fastening device. Specifically, fastening device 130 is in the form of a threaded element or screw that is manipulable by a tool 110 (FIG. 6). The fastening device provides enhanced security since common tools are generally ineffective to manipulate the device, thereby preventing tampering by unauthorized parties as described above. Fastening device 130 includes a distal threaded member 132 and a tool receptacle 134 disposed at a device proximal portion. The threaded member is in the form of a substantially cylindrical rod extending distally from a substantially central location on the receptacle distal end with threads disposed on an exterior rod surface. Receptacle 134 is substantially cylindrical and includes a diameter greater than that of the threaded member. The receptacle extends proximally from the threaded member and includes a closed distal end and an open proximal end with a flange 140 extending radially from the peripheral edge of the receptacle proximal end.

A substantially cylindrical channel 146 is defined within the receptacle including a guide element 144 generally concentrically disposed therein. The channel includes dimensions sufficient to receive tool 110 as described below. The guide element is in the form of a substantially cylindrical post attached to the receptacle closed distal end and extending proximally therefrom toward the receptacle open proximal end. The post diameter is smaller than that of channel 146 to define a substantially annular gap within the channel between the guide element and the interior surface of the receptacle.

The receptacle distal portion includes a plurality of windows 138 and corresponding block members 136 disposed between adjacent windows. The windows are angularly spaced about the receptacle in a generally uniform manner. By way of example, the receptacle may include three uniformly spaced windows separated by three block members. The windows and blocks are substantially rectangular with each window including dimensions sufficient to engage tool 110. The side edges of the blocks form contact areas 151 that serve as stop mechanisms to facilitate rotation of the fastening device as described below. A series of grooves or flutes 142 are defined in the receptacle interior surface. The flutes include an arcuate configuration and are angularly spaced from each other in a generally uniform manner. The flutes extend axially from flange 140 to an intermediate section of an associated window 138. Each flute is configured to receive and guide tool 110 into the associated windows and to enable the tool to engage and manipulate the fastening device as described below.

Threaded member 132 typically engages an opening defined within an object, where a specialized tool is utilized to manipulate the fastening device to engage or disengage the object (e.g., to tighten or loosen) as described below. Since common tools are generally ineffective with respect to the fastening device, the device enhances security and prevents tampering by unauthorized parties. A tool for manipulating fastening device 130 according to the present invention is illustrated in FIG. 6. Specifically, tool 110 includes a distal engaging member 114, a shank or shaft 116, and a proximal gripping member 118. Shank 116 includes a substantially cylindrical body including a distal end and a proximal end. Gripping member 118 is in the form of a rod that is transversely disposed through a proximal portion of shank 116. The rod may be fixed and/or disposed through the shank in any suitable fashion (e.g., welding, a screw or a fastening pin inserted through the tool, apertures, etc.). The gripping member is configured to permit a user to grasp the tool in order to manipulate fastening device 130 (FIG. 5).

Engaging member 114 extends distally from the shank distal end. The engaging member is substantially cylindrical and contoured for compatibility with the interior surface of receptacle 134 (FIG. 5). The engaging member includes an open distal end and a substantially cylindrical channel 122 defined therein to receive guide element 144 and enable the tool to engage the fastening device as described below. The engaging member further includes a diameter smaller than that of the shank to form a shoulder 115 at the juncture between the shank and engaging member. The shoulder may serve as a seating surface for flange 140 when the tool engages the fastening device as described below. A series of bosses or pins 112 is disposed on the exterior surface of the engaging member toward the engaging member distal end. The pins are generally semi-cylindrical, extend radially from the engaging member exterior surface, and are angularly spaced about the engaging member in a manner corresponding to flutes 142 of the fastening device receptacle. The pins are each configured for insertion within a corresponding flute 142 in a slidable relation. The engaging member includes a length sufficient to enable the pins to traverse flutes 142 and be positioned within a corresponding window 138. The pins apply force to contact areas 151 of block members 136 to manipulate the fastening device in response to the user applying torque to tool 110 as described below.

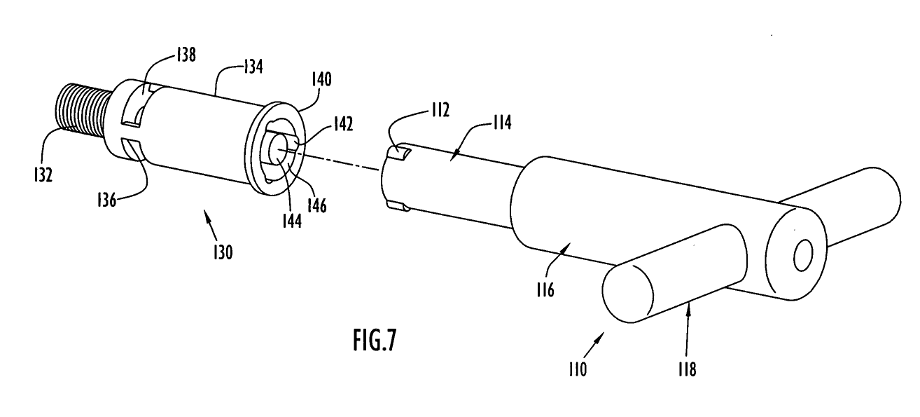

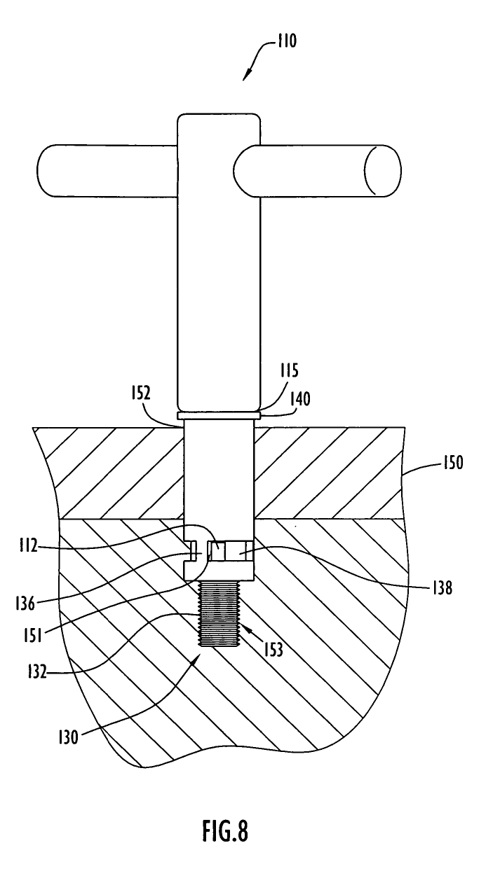

The manner in which tool 110 engages fastening device 130 is illustrated in FIG. 7. Specifically, the distal end of tool 110 is axially inserted into the fastening device open proximal end and through receptacle channel 146. Guide element 144 is received within tool channel 122, while pins 112 are disposed within corresponding flutes 142. The tool is urged distally to position shoulder 115 proximate flange 140 and to enable pins 112 to traverse flutes 142 and be positioned within corresponding windows 138 as described above. The tool may be rotated, if necessary, to turn the engagement member such that the pins traverse the windows and become positioned proximate block members 136. As the tool is rotated, the pins apply force to the contact areas of the block members, thereby rotating the fastening device. This configuration provides enhanced security since common tools are generally ineffective to manipulate the fastening device, thereby preventing tampering by unauthorized parties.

Operation of the alternative fastening system is described with reference to FIG. 8. Initially, fastening device 130 is detachably secured to an object 150 (e.g., a wall, cabinet, etc.) by inserting the fastening device into a passage 152 defined in the object. The passage preferably includes an upper section having dimensions sufficient to receive receptacle 134 and a lower section comprising a threaded channel 153 to engage threaded member 132. In order to rotate the fastening device for engagement with the threaded channel, tool 110 is axially inserted into fastening device receptacle 134 via the open proximal end. Guide element 144 is received in tool channel 122 with pins 112 disposed within corresponding flutes 142. The tool is urged axially into the channel such that shoulder 115 becomes positioned proximate flange 140 and pins 112 traverse the flutes and become positioned in corresponding windows 138. The tool may be rotated, if necessary, to enable the pins to traverse the windows and become positioned proximate corresponding block members 136. The tool may be rotated to press the pins against the contact areas of the block members and rotate or manipulate the fastening device to enable threaded member 132 to engage the threaded channel. Preferably, once secured, the fastening device receptacle is generally inset with respect to the exterior surface of the object (e.g., flange 140 is generally flush with the object surface) to prevent tampering with common tools. The tool may be rotated in a reverse direction to release fastening device 130 from the object.

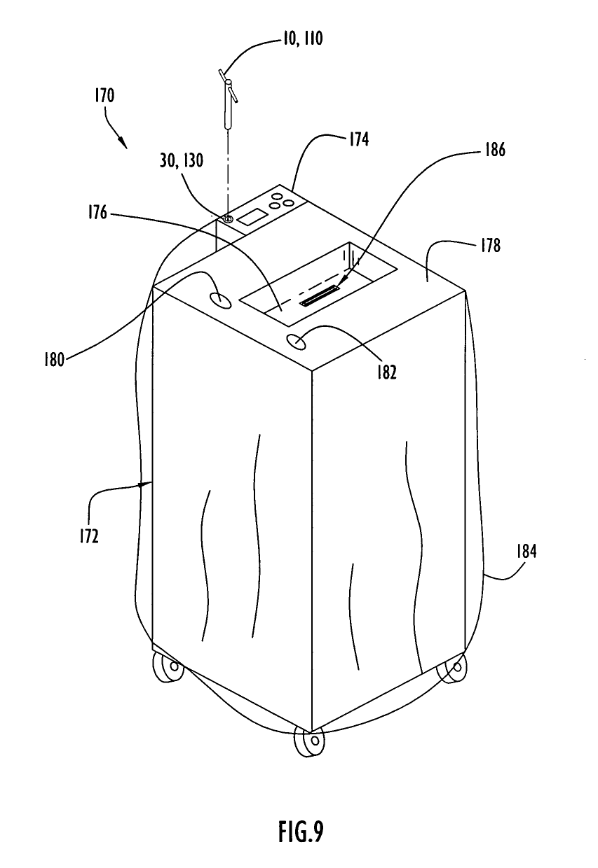

The fastening systems described above may be used for any fastening applications. For example, the systems may be employed by thermal treatment systems as illustrated in FIG. 9. Initially, the thermal treatment system may be of the types of systems disclosed in U.S. Patent Application Publication No. 2003/0172937 (Faries, Jr. et al.) and U.S. Pat. No. 6,810,881 (Faries, Jr. et al.), the disclosures of which are incorporated herein by reference in their entireties. Specifically, a thermal treatment system 170 to thermally treat a medical solution includes a cabinet or housing 172, a wiring housing 174 attached to the cabinet and a warming basin 176 recessed into a cabinet top surface 178. Basin 176 may be of any shape, however, by way of example only, the basin is illustrated as being substantially rectangular. A heater power switch 180 and a temperature controller/indicator 182 are provided on top surface 178 toward the cabinet front wall with the warming basin residing between the power switch and controller. Wiring housing 174 is attached to the cabinet side wall that is closest to heater power switch 180 and facilitates system connections as described below. A heater (not shown) is disposed on the underside of the basin to heat the basin and a sterile medium contained therein. The heater is controlled by controller 182 in accordance with an entered desired temperature and temperatures measured by a temperature sensor (not shown). It is to be understood that the thermal treatment system described above may have various configurations. For example, the thermal treatment system may be configured to cool and/or congeal the medium to produce cooled liquid or surgical slush. In this instance, the heater may be replaced by refrigeration devices. The system thermal devices are controlled in response to detection of solution and leaks within the drape container as described below. Further, the thermal treatment system may include a plurality of basins warming and/or cooling a sterile medium. Examples of cooling and/or plural basin systems are disclosed in the above-mentioned Faries, Jr. et al. patent documents.

A sterile drape 184, preferably transparent, is typically disposed over the top and sides of cabinet 172 and made to conform to the side wall and bottom of basin 176. Power switch 180 and controller 182 are disposed on top surface 178 of system cabinet 172 and are adjustable manually through drape 184. The portion of drape 184 disposed in basin 176 serves as a sterile container or receptacle for sterile liquid placed therein to be heated. In order to detect the presence of liquid and/or leaks within the drape container to maintain drape integrity and sterility of the sterile medium, drape 184 includes a sensing device 186. The sensing device is in the form of a pair of electrodes. The distal ends of the electrodes are attached to a plug or connector that interfaces detection circuitry within the thermal treatment system. The electrodes pass through the drape from the sterile to the non-sterile drape sides via an opening or slit defined in the drape. The sensing device detects the presence of liquid and leaks within the drape container in response to current flow between the electrodes and ground (e.g., the basin beneath the drape) indicating various conditions. The current flow causes a respective change in voltage that is detected by detection circuitry within the thermal treatment system. Wiring housing 174 receives signals from the electrodes and includes wiring to transfer signals between that housing and the detection circuitry to control system operation in accordance with the varying basin conditions (e.g., disable system operation in response to a leak or no solution within the basin, etc.). For further examples of the thermal treatment system, reference is made to the aforementioned Faries, Jr. et al. patent documents.

In order to prevent tampering with the leak detection circuitry, wiring housing 174 may employ the fastening systems of the present invention. In this example, fastening devices 30, 130 and corresponding tools 10, 110 are employed to fasten wiring housing 174 in a secure manner and prevent access to or tampering with internal components by unauthorized parties that may result in injury to patients. However, the fastening systems may be utilized to fasten any desired system components (e.g., the system housing to secure leak detection or other circuitry, system storage or other cabinets, system housings, system controls, system thermal device, etc.).

It will be appreciated that the embodiments described above and illustrated in the drawings represent only a few of the many ways of implementing a fastening system and method of fastening objects with enhanced security.

The fastening devices may be of any shape or size and may be constructed of any suitable materials. The fastening devices may be formed as an integral unit or the components (e.g., receptacle, threaded member, etc.) may be attached via any conventional or other techniques (e.g., welding, etc.). The threaded member of the fastening devices may be of any quantity, shape or size (including sizes larger, smaller or equal to those of the receptacle), may be disposed at any suitable locations and may be constructed of any suitable materials. The threaded members may include any types of threads disposed at any suitable locations. The threads may be disposed on the entire or any portion of those members. The threaded members may alternatively include any conventional or other configuration for attachment to an object.

The tool receptacle of the fastening devices may be of any quantity, shape or size (e.g., larger, smaller or equal to those of the threaded member), may be disposed at any suitable locations and may be constructed of any suitable materials. The receptacles may include any configuration for mating with a corresponding tool. The receptacle flange of the fastening devices may be of any quantity, shape or size, may be disposed at any locations and may be constructed of any suitable materials. The receptacle channel of the fastening devices may be of any quantity, shape or size, and may be defined within the fastening devices at any locations in any fashion. The receptacle guide element of the fastening devices may be of any quantity shape or size, may be disposed at any suitable locations and may be constructed of any suitable materials. The guide element base may be of any quantity, shape or size, may be disposed at any locations and may be constructed of any suitable materials. The guide element rod may be of any quantity, shape or size, may be disposed at any locations and may be constructed of any suitable materials. The guide element post may be of any quantity, shape or size, may be disposed at any locations and may be constructed of any suitable materials.

The window or cutout section may be of any quantity, shape or size and may be disposed at any location on the receptacle (e.g., in a uniform or non-uniform manner). The windows may be of any quantity, shape or size and may be disposed at any locations on the receptacle (e.g., in a uniform or non-uniform manner). The block members may be of any quantity, shape or size and may be disposed at any locations on the receptacle. The flutes may be of any quantity, shape or size, and may be disposed or defined at any suitable locations on the receptacle (e.g., in a uniform or non-uniform manner). The flutes and windows may be angularly arranged or spaced on the receptacle in any fashion, where the flutes may interface the windows at any locations. The receptacles of the fastening devices may alternatively include any configuration to engage a corresponding tool to manipulate the fastening devices.

The tools may be of any shape or size and include any configuration that accommodates the fastening device including the device receptacle. The tools may be formed as an integral unit or the components (e.g., gripping member, shank, engaging member, etc.) may be attached via any conventional or other techniques (e.g., welding, etc.). The gripping member of the tools may be of any quantity, shape or size, may be disposed at any locations in any orientations and may be constructed of any suitable materials. The gripping members may be attached to the shanks via any conventional or other techniques (e.g., formed integral, welding, insertion through apertures, etc.). The gripping members may include any configuration that permits a user to apply force to the tools to manipulate the fastening devices. The shank of the tools may be of any quantity, shape or size, may be disposed at any locations and may be constructed of any suitable materials. The shank channel may be of any quantity, shape or size and may be defined in the shank at any suitable locations.

The protrusion or tab may be of any quantity, shape or size, may be disposed at any suitable location and may be constructed of any suitable materials. The tab may be oriented relative to the shaft in any fashion (e.g., linear, radial outward/inward extension, etc.) for insertion within the cutout section. The tab is preferably substantially flush with the receptacle exterior within the cutout section, but may be positioned in any fashion relative to that exterior. The tab may include any type of configuration (e.g., arcuate, linear, etc.) for insertion within the cutout section. The engaging member of the tools may include any quantity of pins or other projections of any shape or size and constructed of any suitable materials. The pins may be disposed at any suitable locations and arranged about the engaging member in any fashion. The engaging member of the tools may be of any shape or size and may be disposed at any locations on the shank. The engaging member channel may be of any quantity, shape or size and may be defined in the engaging member at any suitable locations. The engaging member of the tools and the fastening devices may alternatively include any mating configuration enabling manipulation of the fastening devices.

The fastening devices may be utilized to fasten any types of objects or to mount objects on any support structures (e.g., walls, etc.). The objects and/or support structures may include any quantity of any types of openings, passages or channels of any shapes or sizes and disposed at any locations to accommodate the fastening devices. The openings may be threaded or include other mechanisms or techniques for securing the fastening devices. A fastening device may include any quantity of receptacles to accommodate any quantity of tools to manipulate the fastening device. Further, the fastening devices and tools described above may be utilized individually or in any combination to fasten objects. Moreover, the tools may be manipulated manually or by any power devices (e.g., drill, etc.) to manipulate a fastening device. In addition, the tool may be in the form of a power tool accessory (e.g., drill bit, etc.) or the fastening devices and tools may include any mating members or configurations to enable a power device to engage and manipulate the tools or fastening devices.

It is to be understood that the terms “top”, “bottom”, “front”, “rear”, “side”, “height”, “length”, “width”, “upper”, “lower”, “vertical” and the like are used herein merely to describe points of reference and do not limit the present invention to any particular orientation or configuration.

The present invention is not limited to the applications described above, but may be utilized to fasten any types of objects to each other or to support structures with enhanced security.

From the foregoing description, it will be appreciated that the invention makes available a novel fastening system and method of fastening objects with enhanced security, wherein a fastening device is manipulable by a specialized tool to secure an object with enhanced security.

Having described preferred embodiments of a new and improved fastening system and method of fastening objects with enhanced security, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1-8. (canceled)

9. A fastening system for reliably fastening objects to enhance security comprising:
a fastening device including:
a threaded section to engage an opening defined within an object,
a receptacle including at least one window, wherein each said window includes a contact area to receive applied force and enable manipulation of said fastening device relative to said object; and
a tool to engage said receptacle and manipulate said fastening device.

10. The fastening system of claim 9, wherein said tool includes a protrusion with edges configured to engage said contact area to manipulate said fastening device.

11. The fastening system of claim 10, wherein said protrusion is substantially flush with an exterior surface of said receptacle when received into said receptacle and positioned within said window.

12. The fastening system of claim 9, wherein;
said receptacle includes an open proximal end and a closed distal end and an interior channel extending therebetween;
said fastening device further includes a guide element disposed within said receptacle interior channel and extending between said receptacle closed distal end and said receptacle open proximal end; and
said tool includes:
an engaging member to engage said receptacle;
a shank portion extending proximally from said engaging member; and
a gripping member disposed toward said shank portion proximal end to enable manipulation of said tool.

13. The fastening system of claim 12, wherein said shank portion includes a channel to receive said guide element.

14. The fastening system of claim 12, wherein said engaging member includes a channel to receive said guide element.

15. The fastening system of claim 12, wherein an internal surface of said receptacle includes at least one flute in communication with said window, and said engaging member includes at least one pin disposed on an exterior surface thereof with each pin configured to slidably engage a corresponding flute.

16. The fastening system of claim 12,
wherein said fastening device is configured to secure a compartment of a thermal treatment system that thermally treats a medical solution.

17. A fastening system for reliably fastening objects to enhance security comprising:
a tool to manipulate a fastening device including:
an engaging member including a protrusion with edges configured to engage and manipulate said fastening device;
a shank portion extending proximally from said engaging member and including a channel defined therein; and
a gripping member disposed toward said shank portion proximal end to enable manipulation of said tool.

18. The fastening system of claim 17, wherein said protrusion is configured to be substantially flush with an exterior surface of said fastening device when received within said fastening device.

19. A fastening system for reliably fastening objects to enhance security comprising:
a tool to manipulate a fastening device including:
an engaging member including a channel defined therein and at least one pin disposed on an external surface to engage and manipulate said fastening device;
a shank portion extending proximally from said engaging member; and
a gripping member disposed toward said shank portion proximal end to enable manipulation of said tool.

20. A method of reliably fastening objects via a fastening system to enhance security, wherein said fastening system includes a fastening device and a tool to manipulate said fastening device, said method comprising:
(a) inserting said fastening device within an opening defined in an object, wherein said fastening device includes a threaded section to engage said opening and a receptacle including at least one window, and wherein each said window includes a contact area to receive applied force and enable manipulation of said fastening device relative to said object;
(b) engaging said fastening device with said tool to manipulate said fastening device relative to said object.

21. The method of claim 20, wherein said receptacle includes an open proximal end, a closed distal end and an interior channel extending therebetween.

22. The method of claim 21, wherein said fastening device further includes a guide element disposed within said receptacle interior channel and extending between said receptacle closed distal end and said receptacle open proximal end, and step (b) further includes:
(b.1) guiding said tool within said receptacle to enable said tool to engage said fastening device.

23. The method of claim 20, wherein said tool includes a protrusion, and step (b) further includes:
(b.1) engaging said contact area with edges of said protrusion to manipulate said fastening device.

24. The method of claim 23, wherein step (b.c) further includes:
(b.1.1) engaging said contact area with edges of said protrusion to manipulate said fastening device, wherein said protrusion is substantially flush with an exterior surface of said receptacle.

25. The method of claim 22, wherein said tool includes an engaging member to engage said receptacle, a shank portion extending proximally from said engaging member and a gripping member disposed toward said shank portion proximal end to enable manipulation of said tool, and step (b.1) further includes:
(b.1.1) receiving said guide element within a channel defined within said shank portion.

26. The method of claim 22, wherein said tool includes an engaging member to engage said receptacle, a shank portion extending proximally from said engaging member and a gripping member disposed toward said shank portion proximal end to enable manipulation of said tool, and step (b.1) further includes:
(b.1.1) receiving said guide element within a channel defined within said engaging member.

27. The method of claim 21, wherein an internal surface of said receptacle includes at least one flute in communication with said window, and wherein said tool includes an engaging member to engage said receptacle and including at least one pin disposed on an exterior surface thereof, a shank portion extending proximally from said engaging member and a gripping member disposed toward said shank portion proximal end to enable manipulation of said tool, and step (b) further includes:
(b.1) slidably engaging each flute of said receptacle with a corresponding pin of said engaging member to position said pins within corresponding windows to manipulate said fastening device.

28. The method of claim 20, wherein step (a) further includes:
(a.1) inserting at least one fastening device within a thermal treatment system for thermally treating a medical solution, wherein said thermal treatment system includes at least one compartment and at least one fastening device secures said compartment.
